(19) United States
(12) Patent Application Publication
(10) Pub. No.: US 2017/0236226 A1
(43) Pub. Date: Aug. 17, 2017

(54) COMPUTERIZED SYSTEMS, PROCESSES, AND USER INTERFACES FOR GLOBALIZED SCORE FOR A SET OF REAL-ESTATE ASSETS

(71) Applicants: Ashutosh Malaviya, San Jose, CA (US); Fan Jiang, San Jose, CA (US); Eric Fang, Albany, CA (US); Jason Hiver Tondu, Coeur d'Alene, ID (US)

(72) Inventors: Ashutosh Malaviya, San Jose, CA (US); Fan Jiang, San Jose, CA (US); Eric Fang, Albany, CA (US); Jason Hiver Tondu, Coeur d'Alene, ID (US)

(21) Appl. No.: 15/270,407

(22) Filed: Sep. 20, 2016

Related U.S. Application Data
(60) Provisional application No. 62/262,802, filed on Dec. 3, 2015.

(51) Int. Cl. G06Q 50/16; G06F 17/30; G06N 5/04; G06Q 30/02; G06Q 10/06

(52) U.S. Cl. CPC G06Q 50/16; G06Q 30/0202; G06Q 10/067; G06N 5/04; G06F 17/30424; G06F 17/30528; G06F 17/30241; G06F 17/30598

(57) ABSTRACT

In one aspect, a computerized method for determining a probability value that a real-estate asset is to be placed on the market for sale includes the step of obtaining a database of real-estate assets. The method includes the step of merging a set of similar near real-estate tracts using a breadth-first search. The method, includes the step of creating a submarket of real-estate assets by performing duster analysis with a hierarchal-clustering method in a county context. The method includes the step of identifying a set of datasets of real-estate assets on a per-county level. The method includes the step of identifying a set of datasets of real-estate assets on a per-state level. The method includes the step of determining a probability that each real-estate asset will be placed for sale based on a set of geo-models. The method includes the step of mapping the probability that each real-estate asset will be placed for sale to a score. The method includes the step of implementing one or more weighting methods on the probability for each geo-model to smooth. The method includes the step of calculating a set of ensemble probabilities for each geo-model. The method includes the step of generating a globalized score for each real-estate asset in the database of real-estate assets.

This application claims priority from U.S. Provisional Application No. 62/262,802, title COMPUTERIZED SYSTEMS, PROCESSES, AND USER INTERFACES FOR GLOBALIZED SCORE FOR A SET OF REAL-ESTATE ASSETS and filed 3 Dec. 2015. This application is hereby incorporated by reference in its entirety for all purposes.

### BACKGROUND

1. Field

This application relates generally to computerized platform for machine learning and predictive modeling, and more specifically to a system, article of manufacture and method for globalized score for a set of real-estate assets.

2. Related Art

Computerized platforms can be leveraged to implement machine learning and predictive modeling for real-estate assets. For example, predictive modeling can be used to determine a probability that a residential home (e.g. a ‘property’) will be placed on the market for sale within a specified period of time. Predictive modeling can be based on the real-asset's attributes with a specified tract. However, comparisons with other properties outside a local tract may be useful to real-estate professionals. Accordingly, improvements to determining a globalized score for comparing probability values across various tracts, counties and/or states for a set of real-estate assets can be useful.

### BRIEF SUMMARY OF THE INVENTION

In one aspect, a computerized method for determining a probability value that a real-estate asset is to be placed on the market for sale includes the step of obtaining a database of real-estate assets. The method includes the step of merging a set of similar near real-estate tracts using a breadth-first search. The method includes the step of creating a submarket of real-estate assets by performing cluster analysis with a hierarchal-clustering method in a county context. The method includes the step of identifying a set of datasets of real-estate assets on a per-county level. The method includes the step of identifying a set of datasets of real-estate assets on a per-state level. The method includes the step of determining a probability that each real-estate asset will be placed for sale based on a set of geo-models. The method includes the step of mapping the probability that each real-estate asset will be placed for sale to a score. The method includes the step of calculating a set of ensemble probabilities for each geo-model. The method includes the step of implementing one or more weighting methods on the probability for each geo-model to smooth. The method includes the step of generating a globalized score for each real-estate asset in the database of real-estate assets.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for determining a globalized score for a set of real-estate assets, according to some embodiments.

FIG. 2 illustrates example process for generating a global score for each real-estate asset in a prioritized a list of real-estate assets, according to some embodiments.

FIG. 3 illustrates an example process for implementing data preparation operations, according to some embodiments.

FIG. 4 illustrates an example process or data merging operations, according to some embodiments.

FIGS. 5A-B illustrate an example process n alpha method for correcting a probability value that a real-estate asset will be placed on the market for sale, according to some embodiments.

FIG. 6 illustrates an example process for utilizing an alpha method to adjust probability values for real-estate assets to be place on the market for sale within a specified period of time, according to some embodiments.

FIG. 7 illustrates an example scoring system pipeline, according to some embodiments.

FIG. 8 illustrates an example method for generating a property global score, according to some embodiments.

FIG. 9 illustrates an example process of using various machine-learning algorithms to implement backtesting and make predictions with respect to properties entering the market, according to some embodiments.

FIG. 10 illustrates an example process for obtain quasi-tracts, according to some embodiments.

FIG. 11 illustrates an example process to cluster tracts in a state to contribute submarket, according to some embodiments.

FIG. 12 is a block diagram of a sample computing environment that can be utilized to implement some embodiments.

FIG. 13 depicts an exemplary computing system that can be configured to perform any one of the processes provided herein.

The Figures described above are a representative set, and are not an exhaustive with respect to embodying the invention.

### DETAILED DESCRIPTION

Disclosed are a system, method, and article of manufacture of determining a globalized score for a set of real-estate assets. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

DEFINITIONS

The following are example definitions that can be utilized to implement some embodiments.

Alpha table can be a table that lists the probabilities from each geo-level model, historical model coefficient of variation, historical events rate, etc.

Backtesting can refer to testing a predictive model using existing historic data. Backtesting is a kind of retrodiction, and a special type of cross-validation applied to time series data. Backtesting can be a way to perform selection of covariates and check model predictive ability.

Breadth-first search (BFS) can be an algorithm for traversing or searching tree or graph data structures. BFS can start at the tree root (or some arbitrary node of a graph, sometimes referred to as a ‘search key’) and explores the neighbor nodes first, before moving to the next level neighbors.

Bootstrap aggregating(‘bagging’) can be a machine learning ensemble meta-algorithm designed to improve the stability and accuracy of machine learning algorithms used in statistical classification and regression.

Cluster analysis or clustering is the task of grouping a set of objects in such a way that objects in the same group (called a cluster) are more similar (in some sense or another) to each other than to those in other groups (e.g. clusters).

Data aggregator can be an organization involved in compiling information detailed databases on individuals and providing that information to others.

Ensemble learning can use multiple learning algorithms to obtain better predictive performance than could be obtained from any of the constituent learning algorithms.

Euclidean distance can be a straight-line distance between two points in Euclidean space.

Event rate a measure of how often a particular statistical event (such as those discussed infra) occurs within the experimental group (such as those discussed infra) of an experiment.

F-score, in statistical analysis of binary classification, can be a measure of a test's accuracy. The F-score can consider both the precision ‘p’ and the recall ‘r’ of the test to compute the score. ‘p’ is the number of correct positive results divided by the number of all positive results. ‘r’ is the number of correct positive results divided by the number of positive results that should have been returned. The F-score can be interpreted as weighted average of the precision and recall, where an F-score reaches its best value at 1 and worst at 0.

Fuzzy clustering is a class of algorithms for cluster analysis in which the allocation of data points to clusters is not “hard” (all-or-nothing) but “fuzzy” in the same sense as fuzzy logic.

Haversine formula is an equation that provides great-circle distances between two points on a sphere from their longitudes and latitudes. It is a special case of a more general formula in spherical trigonometry, the law of haversines, relating the sides and angles of spherical “triangles”.

Hierarchical clustering can be a method of cluster analysis that seeks to build a hierarchy of clusters.

K-means clustering can be a method of vector quantization used for cluster analysis in data mining.

Logistic regression can include, inter alia, measuring the relationship between the categorical dependent variable and one or more independent variables, which are usually (but not necessarily) continuous, by using probability scores as the predicted values of the dependent variable.

Macro score can be a global score. The global score can be an adjusted score for which each property across a geographic region (e.g. nationwide) could be comparable.

Manhattan distance measures distance following only axis-aligned directions.

OOB (out-of-bag) data can measure performance of random forest. OOB methods can be used to obtain a running unbiased estimate of the classification error as trees are added to the random forest. OOB methods can also be used to obtain estimates of variable importance.

Property be a real-estate asset (e.g. a residential home, an office building, a tract of land, etc.).

Quasi-tracts can be defined as similar to nearby tracts. For example, a quasi-tract can be a small tract with a low property count or a tract with a low listing/transaction rate. Various values, such as, median family income, median housing price and haversine distance between tracts can be utilized to define quasi-tracts.

Random forest can be an ensemble learning method for classification, regression and, other tasks, that operate by constructing a multitude of decision trees at training time and outputting the class that is the mode of the classes (e.g. classification) or mean prediction (e.g. regression) of the individual trees. Random forests can correct for decision trees ‘habit’ of overfitting to their training set. As an ensemble method, random Forest can combine one or more ‘weak’ machine-learning methods together. Random forest can be used in supervised learning (e.g. classification and regression), as well as unsupervised learning (e.g. clustering).

Real estate can be property consisting of land and the buildings on it, along with its natural resources such as crops, minerals, or water; immovable property of this nature; an interest vested in this; an item of real property; buildings or housing in general.

Real estate broker or real estate agent can be a person who acts as an intermediary between sellers and buyers of real estate/real property and attempts to find sellers who wish to sell and buyers who wish to buy. As used herein, a realtor can be a real estate broker, real estate agent and/or other similar real estate profession service provider.

Smoothing a data set can be to create an approximating function that attempts to capture important patterns in the data, while leaving out noise or other fine-scale structures/rapid phenomena.

Tract can geographic region defined for the purpose (e.g. taking a census, voting precinct, other governmental region, housing tract, subdivision of a housing tract, etc.).

Training set can be a set of data used in various areas of information science to discover potentially predictive relationships. Training sets can be used in artificial intelligence, machine learning, genetic programming, intelligent systems, and statistics. The training set data should not be confused of testing set data. Test data set can be a set of data used in various areas of information science to assess the strength and utility of a predictive relationship.

Exemplary Methods

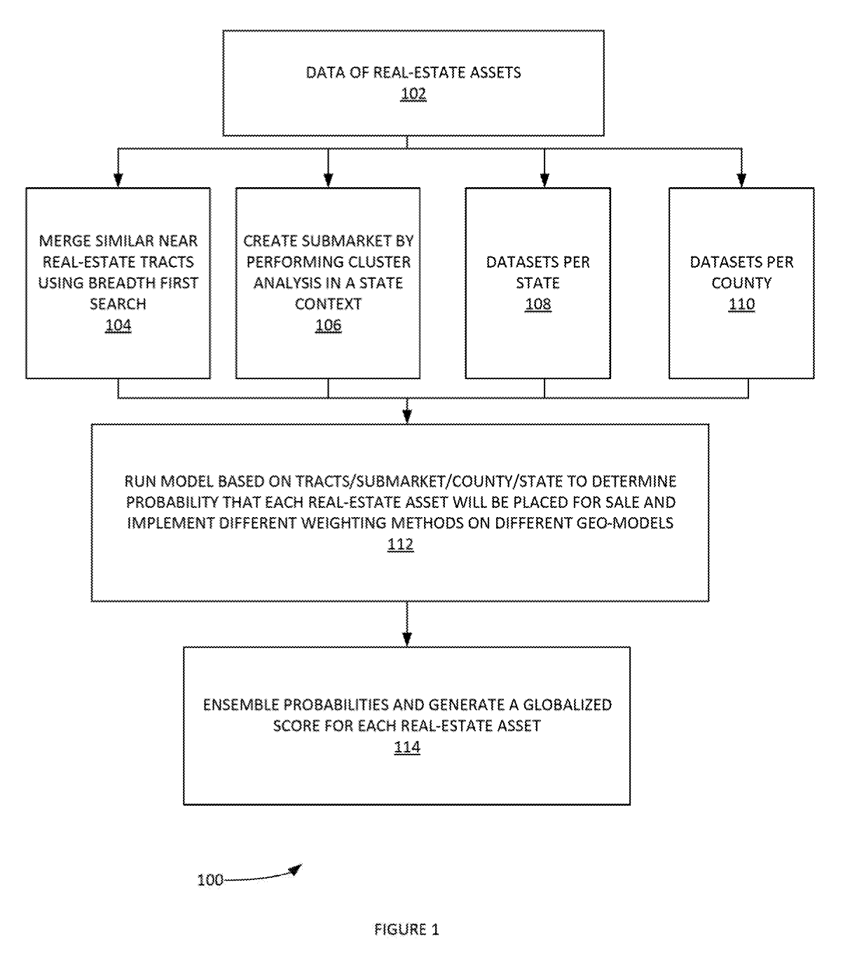

FIG. 1 illustrates an example process 100 for determining a globalized score for a set of real-estate assets, according to some embodiments. The globalized score can be used to generate a prediction model for prioritizing a list of real-estate assets in some example embodiments. In step 102, process 100 can obtain data of real-estate assets. In step 104, process 100 can merge similar near real-estate tracts using a breadth-first search. As used herein, ‘near’ can include a physical distance and/or a measure of similar attributes such as “median family income”, “median home price”, “similar school district”, etc.

In step 106, process 100 can create a submarket by performing duster analysis in a state context. In one example, in step 106, process 100 can generate a dataset of submarkets that includes similar and/or nearby real-estate properties. Process 100 can run different geo-level models, including, inter alia, quasi-tracts, submarkets, counties and states, etc. Process 100 can then run different weighting methods to adjust probabilities. Process 100 can then proceed with ensemble probabilities and generate a macro-score and tract score for each real estate asset. An ensemble can be a probability distribution for the state of the system.

In step 108, process 100 can generate datasets on a per-county level. In step 110, process can generate datasets on a per-state level. In step 112, process 100 can run model based on tracts/submarket/county/state to determine a probability that each real-estate asset will be placed for sale and implement different weighting methods on different geo-models. In step 114, process 100 can obtain ensemble probabilities and generate a globalized score for each real-estate asset.

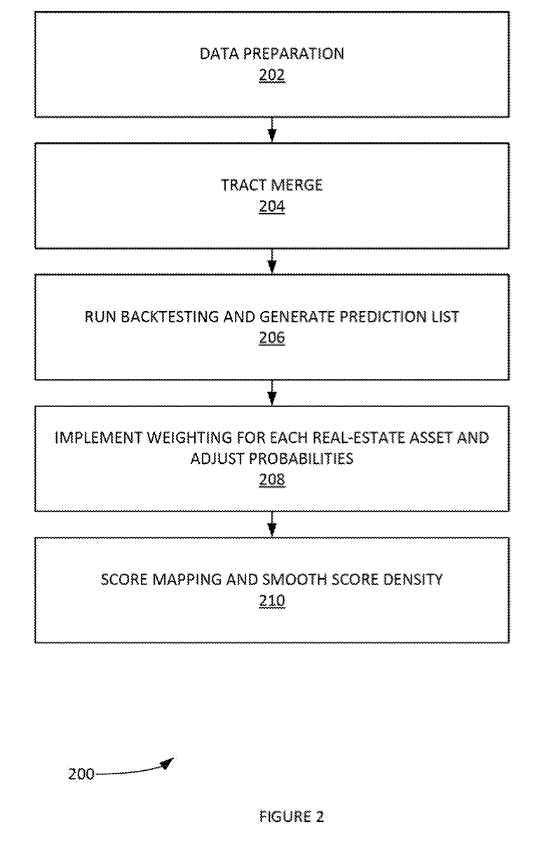

FIG. 2 illustrates an example process 200 for generating a global score for each real-estate asset in a prioritized a list of real-estate assets, according to some embodiments. In step 202, process 200 can implement data preparation operations. In step 204, process 200 can implement data merge operations. In step 206, process 200 can run backtesting, generating prediction list and/or suppression operations. In step 208, process 200 can implement weighting for correction operations and implement weighting to adjust probability. In step 210, process 200 can implement score mapping. After generating score for each asset, two additional steps can be taken: score smoothing to make score distribution more smooth and/or score change control (see infra). This can be done to avoid dramatic monthly score change.

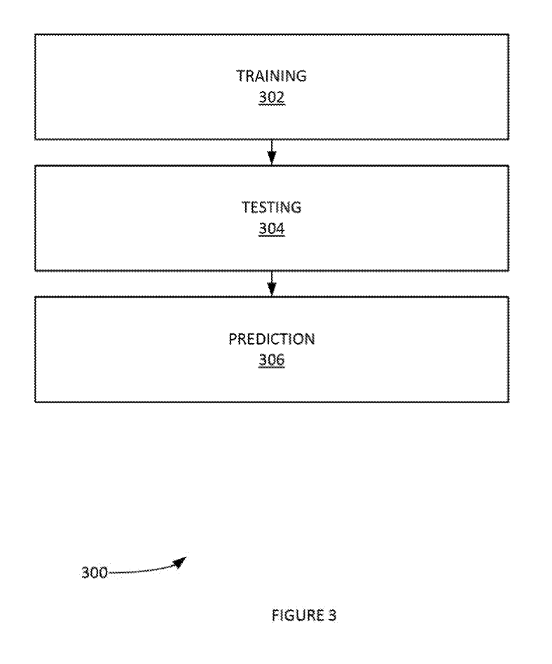

FIG. 3 illustrates an example process 300 for implementing data preparation operations, according to some embodiments. Process 300 can be utilized in portions of process 200 discussed supra. In some embodiments, process 300 can implement real-estate entity segmentation (e.g. as provided in U.S. patent application Ser. No. 14/615,444, titled SEAL-ESTATE CLIENT MANAGEMENT METHOD AND SYSTEM and filed on 6 Feb. 2015. U.S. patent application Ser. No. 14/615,444 is incorporated herein by its entirety). In one example, process 300 can implement same three periods of data as a SmartTargeting® process, including, inter alta: training operations in step 302, testing in step 304 and prediction operations in step 306. Additional columns of information can be utilized in a prediction table.

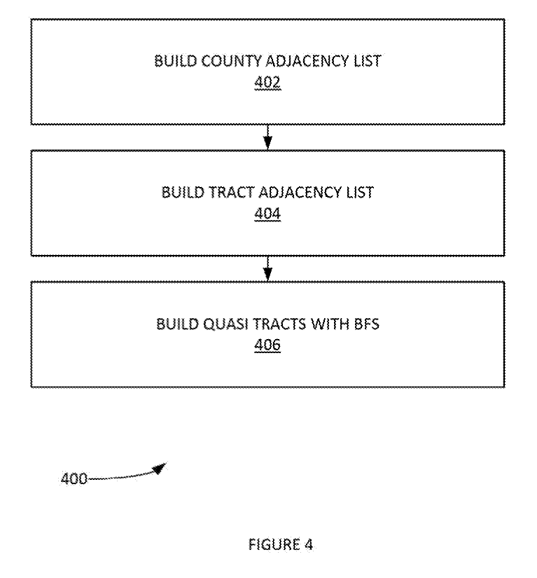

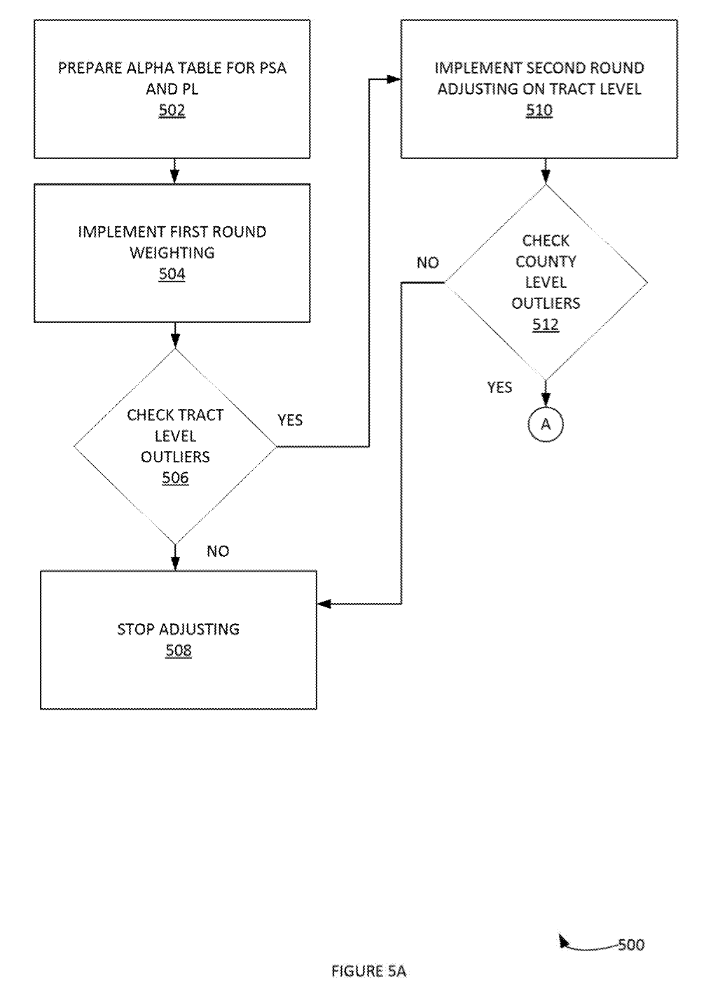

FIG. 4 illustrates an example process 400 for data merging operations, according to some embodiments. It is noted that, in some examples, a tract merging process can be performed on small tracts (e.g. property count <one-thousand (1000)) and/or some tracts which do not have enough sufficient transaction or listing assets (transaction or listing rate <two point five percent (2.5%) annually).

In step 402, process 400 can build an adjacency list for counties. In step 404, process 400 can build a tract adjacency list. In step 406, process 400 can build quasi-tracts based on a specified search algorithm (e.g. a BFS search, etc.). It is further noted that quasi-tracts can be across adjacent counties. It is noted that quasi-tracts can be defined to stay in the same state. Process 400 can also consider, inter alia, median family income, median housing price, and haversine distance between two tracts to calculate similarity.

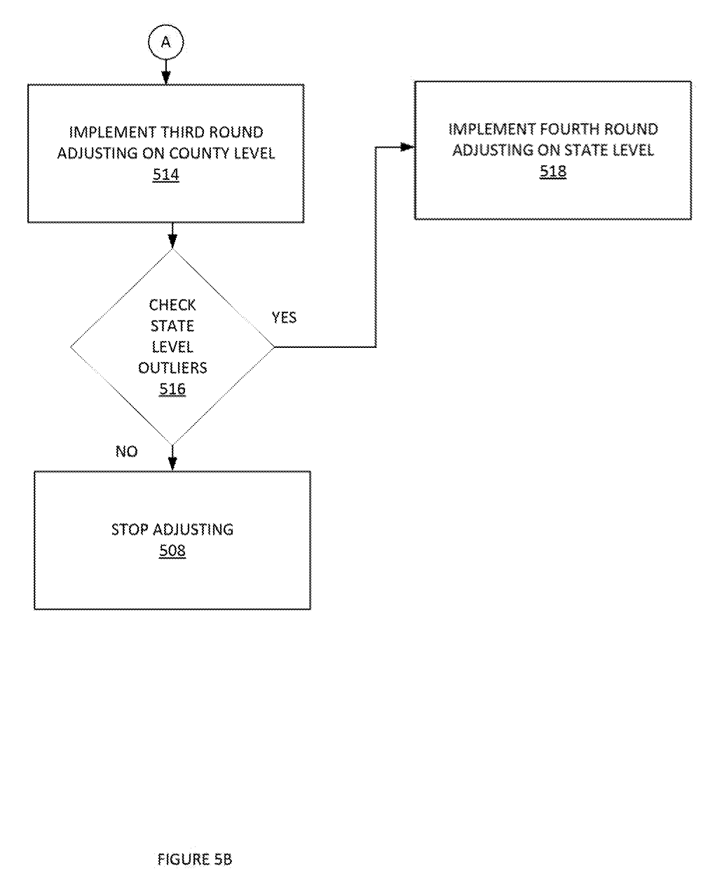

FIGS. 5A-8 illustrate an example process of an alpha method 500 for correcting a probability value that a real-estate asset will be placed on the market for sale, according to some embodiments. In step 502, process 500 can prepare alpha table for PSA and PL methods. PSA method can include backtesting steps, steps that utilize historical data to check how model performs and how to select features. A PL method can include prediction steps and steps that utilize current data to make a prediction. In step 504, process 500 can implement a first-round weighting step.

In step 506, process 500 can check tract level outliers. If there, are no tract level outliers, then process 500 can stop adjusting in step 508. If tract level outliers are extant, process 500 can implement a second round adjusting at the tract level in step 510. Process 500 can then proceed to step 512. In step 512, process 500 can check county level outliers. If there are no county level outliers, then process 500 can stop adjusting in step 508. If county level outliers are extant, process 500 can implement a third round adjusting at the county level in step 514. Process 500 can proceed to step 516. In step 516, process 500 can check state level outliers. If there are no state level outliers, then process 500 can stop adjusting in step 508. If state level outliers are extant, process 500 can implement a fourth round adjusting at the tract level in step 518.

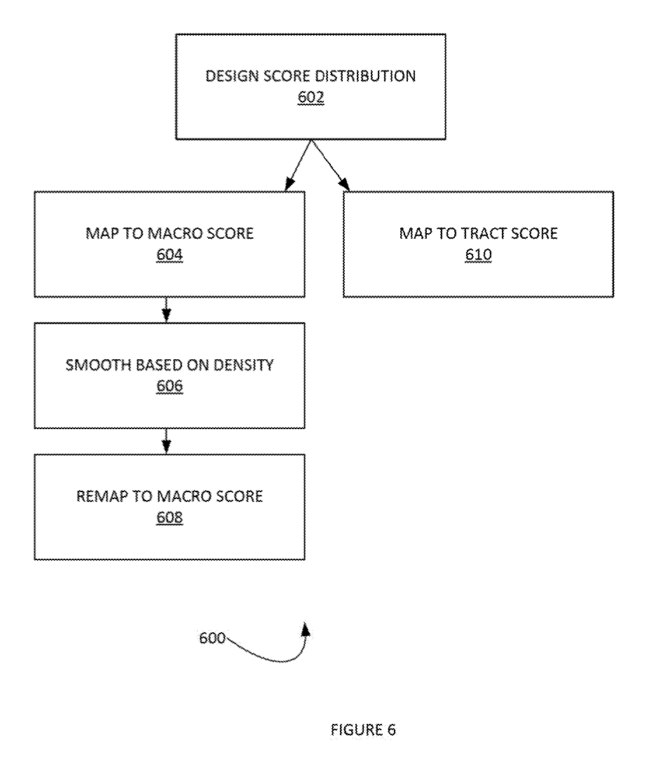

FIG. 6 illustrates an example process 600 for utilizing an alpha method to adjust probability values for real-estate assets to be place on the market for sale within a specified period, according to some embodiments. In step 602, process 600 can implement design scare distribution. In step 604, process 600 can map to a macro score (e.g. mapping a probability to a score). After mapping probability to score, scores can cluster around some ranges. In step 606, process 600 can smooth the output of step 604 based on a density value (e.g. a property density per score). For example, any jumps in the distribution can be smoothed. In step 608, process 600 can rewrap to a macro score. In step 612 process 600 can map to a tract score.

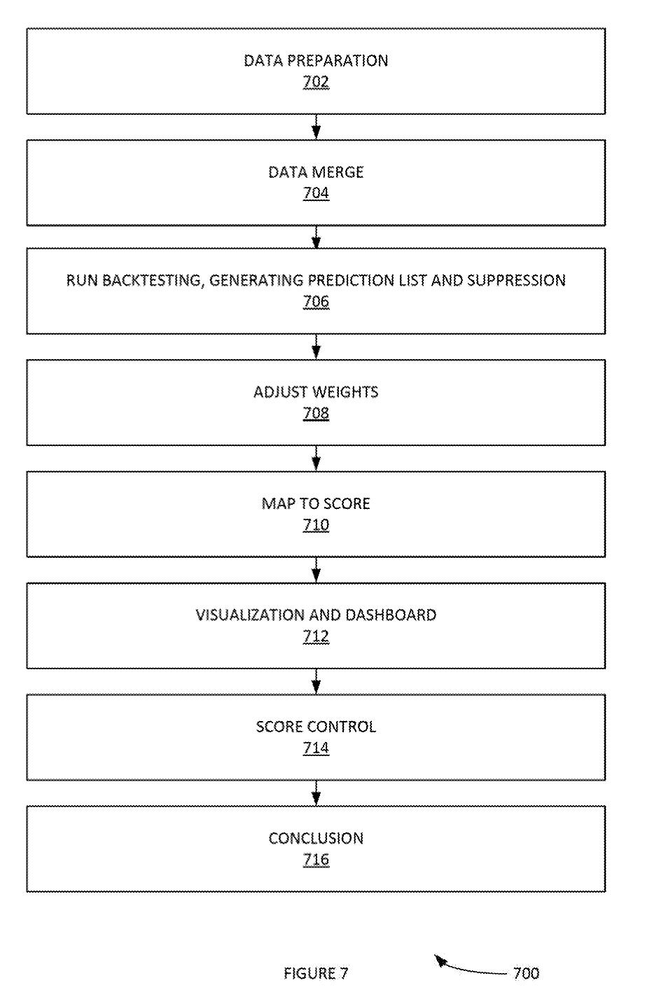

FIG. 7 illustrates an example scoring system pipeline 700, according to some embodiments. In step 702, process 700 can implement data preparation operations. In step 704, process 700 can implement data merge operations. In step 706, process 700 can run backtesting, generating prediction list and suppression operations. In step 708, process 700 can adjust weights. In step 710, process 700 can implement a map to score operation. In step 712, process 700 can implement visualization, and dashboard operations. In step 714, process 700 can implement score control operations. In step 716, process 700 can implement conclusion operations. Example conclusion operations can include, inter alia: an accumulated property percentage/accumulated) lift/accumulated event rate in each hundred scores and/or in five (5) buckets; a monthly accumulated property percentage/lift; a monthly listing/transaction records count; a monthly bucket move-out and move-in; a geographical heat map of hot market and high score area; etc.

In one example, a macro score range can be 125-975. Process 700 can group a macro score into five (5) buckets as follows: [800, 975]: very likely bucket ˜20% of accumulated properties, [700, 799]: likely bucket ˜40% of accumulated properties; [400, 699]: neutral bucket ˜85% of accumulated properties; [200, 399]: unlikely bucket ˜95% of accumulated properties; [125, 199]: suppression bucket ˜100% of accumulated properties. In suppression bucket, process 700 can put just properties listed for one (1) month properties and/or transacted in last year.

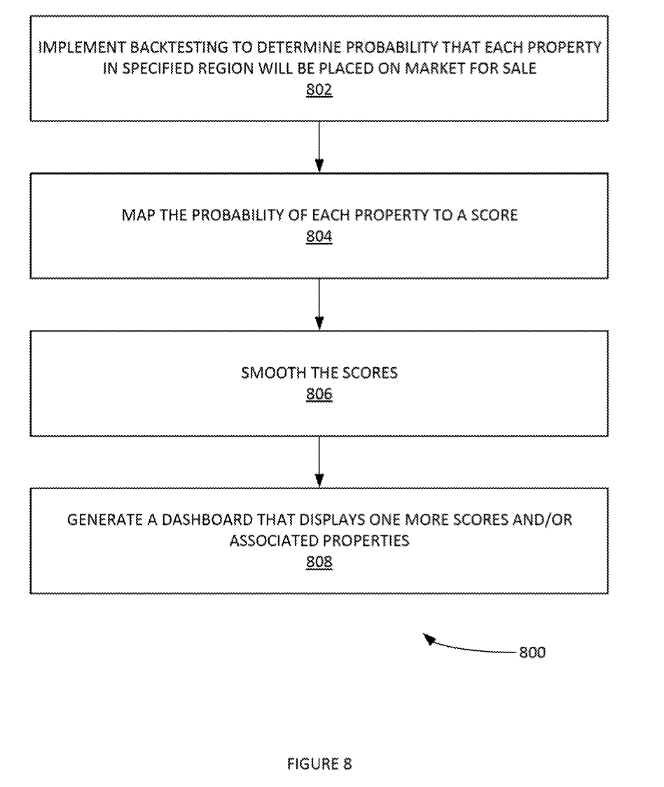

FIG. 8 illustrates an example method 800 for generating a property global score, according to some embodiments. A global score can be a score that is related to a probability that a property will be placed on the market (e.g. placed for sale, etc.) within a specified period of time. A global score can be comparable for properties in between different territories (e.g. different geographical regions, etc.).

In step 802, process 800 can implement backtesting to determine probability that each property in a specified region will be placed on the market for sale. In step 804, process 800 can map the probability of each property to a score. In step 806, process 800 can then smooth the scores. The information generated by process 800 can be aggregated and rendered for display on a computerized user interface (e.g. in a dashboard-type format, in a mobile-device application, etc.). For example, in step 308, process 800 can generate a dashboard that displays one more scores and/or associated properties.

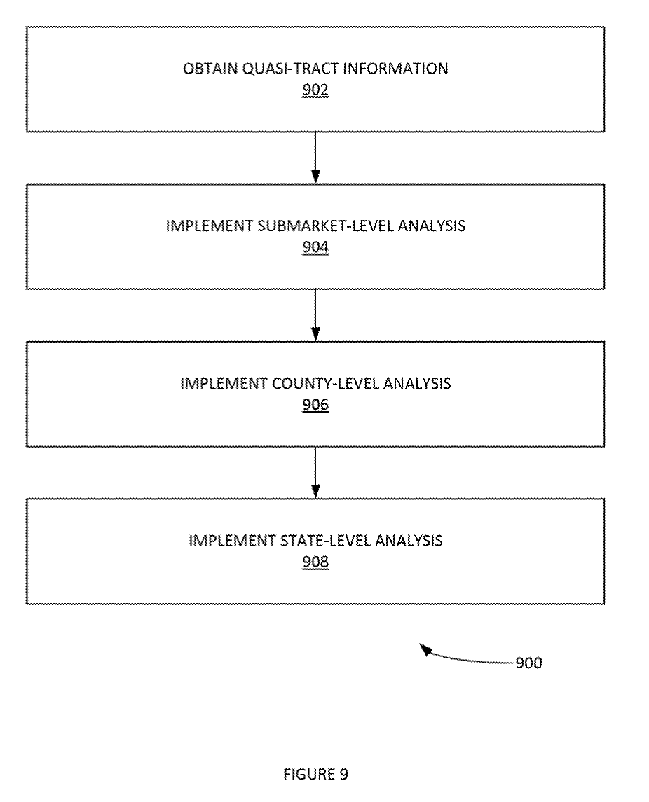

FIG. 9 illustrates an example process 900 of using various machine-learning algorithms to implement backtesting and make predictions with respect to properties entering the market, according to some embodiments. In step 902, process 900 can implement tracts and quasi-tracts level analysis. For example, step 902 can obtain quasi-tract information. Step 902 can implement backtesting and prediction algorithms on said quasi-tract information. Step 902 can then assign and iteratively adjust weights for each tract and/or quasi-tract.

In step 904, process 900 can implement submarket-level analysis. For example, step 904 can cluster tracts (and/or quasi-tracts) into subrnarkets. Step 904 can implement backtesting and prediction algorithms on said submarkets. Step 904 can then assign weights for each submarket. In some examples, step 904 can implement clustering under the state level. Step 904 can implement clustering at the county level if county level property count is large enough (e.g. a county with a high population that is comparable to a state population, etc.). However, step 904 can be implemented above the county level if don't have enough property or events. Step 904 can cluster tracts into a submarket under a specified state (e.g. using k-means clustering, etc.). In another example, step 904 can cluster properties into a submarket under a state with a hierarchical clustering method. A cluster can set as a submarket. Submarkets can share similarities within cluster.

In step 906, process 900 can implement county-level analysis. Step 906 can implement backtesting and prediction algorithms on said counties. Step 906 can then assign weights for each county.

In step 908, process 900 can implement state-level analysis. Step 908 can implement backtesting and prediction algorithms on said states. Step 908 can then assign weights for each state.

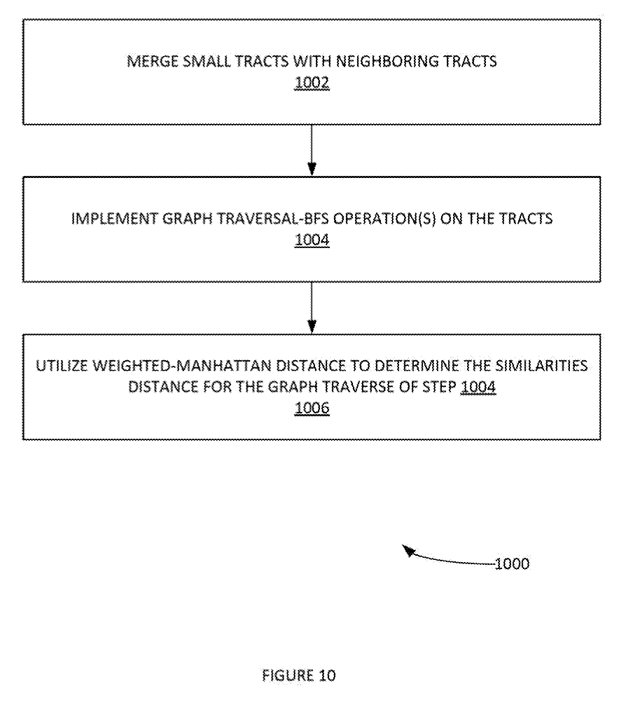

FIG. 10 illustrates an example process 1000 for obtain quasi-tracts, according to some embodiments. Process 1000 can ensure that territories have sufficient records to build models, in terms of, inter alia: a number of houses that may be transacted or listed, a number of houses in the territory, etc. In step 1002, process 1000 can merge small tracts with neighboring tracts. Several merged small tracts can be defined as quasi-tracts. In step 1004, process 1000 can implement graph traversal-BFS operation(s) on the tracts. In step 1006, process 1000 can a utilize weighted-Manhattan distance to determine the similarities distance for the graph traverse of step 1004. For example, the similarities distance can be calculated by tract median home price, median family income and/or geographic distance between tracts.

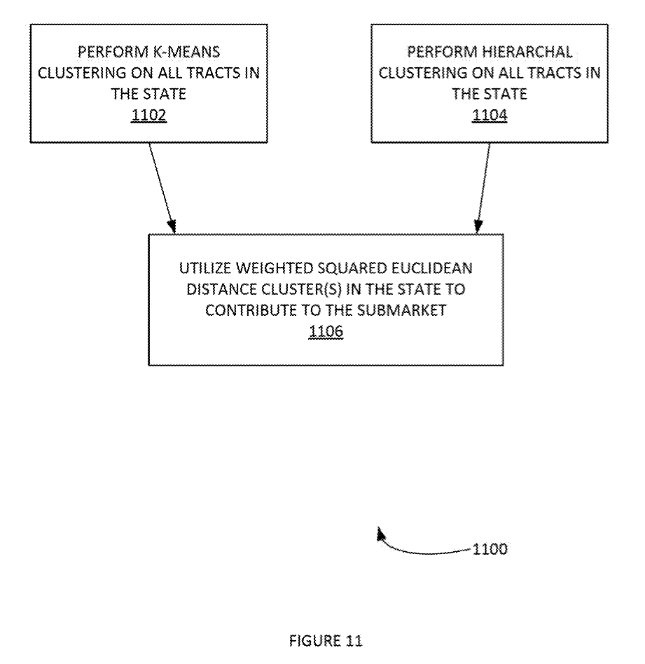

FIG. 11 illustrates an example process 1100 to cluster tracts in a state to contribute submarket, according to some embodiments. Process 1100 can be used to ensure that territories (e.g. a specified geographic region type such as tract, quasi-tract, county, state, etc.) have sufficient records to build a prediction model(s) (e.g. in terms of number of houses to listed, the number of houses in the territory, etc.). In step 1102, process 1100 can perform k-means clustering on all tracts in the state. In step 1104, process 1100 can perform hierarchical clustering on all properties in a county. In step 1106, process 100 can utilize weighted-squared Euclidian distance to cluster tracts in a state to contribute to a submarket.

It is noted that process 1100 can cluster tracts into submarkets under a state using K-means clustering. Process 100 can also cluster properties into a submarket under a county with a hierarchical clustering method. A cluster can be a submarket. Submarkets can share similarities within cluster. Process 1100 can be used to ensure that territories (e.g. submarkets, etc.) have sufficient records to build a prediction model(s) (e.g. in terms of number of houses to listed, the number of houses in the territory, etc.).

In some examples, process 1100 can perform K-means clustering on all tracts in a state to group said tracts based on a probability of being placed on the market for sale. K-means clustering can partition ‘n’ observations (e.g. two or more tracts) into ‘k’ clusters in which each observation belongs to the cluster with the nearest mean, serving as a prototype of the cluster. A similarities distance can be calculated by, inter alia: tract median home price, median family income, centroid latitude and longitude of tract, etc.

Process 1100 can also perform hierarchical clustering. For example, process 1100 can perform hierarchical clustering on all properties in a county to group properties based on probability of being placed on the market for sale. The similarities distance can be calculated by, inter alia: price per square feet, school rating and safety etc.

It is noted that backtesting and forward prediction can be implemented. For example, various backtesting models can be on various geographic-region levels (e.g. track, quasi-track, county, state, etc.). This can then be used to generate predictions with respect to whether a set of one or more properties (e.g. homes, office buildings, condominiums, etc.) will be placed on the market for sale.

The output of processes 100-1000 can be formatted for transmission through a computer network (e.g. the Internet, a wireless network/channel, etc.) to one or more subscribers. In one example, a method of distributing a probability value that a real-estate asset is to be placed on the market for sale over a network to a remote subscriber computer is provided. A user-side application (e.g. based upon a subscriber's destination address and transmission schedule) can receive said output(s). The output(s) can be automatically formatted and presented via a dashboard application, a web page, a mobile-device application and/or automatically printed by a printing device. A connection via a URL to a data source can be enabled over the Internet (e.g. when a user-side computing device is locally connected to the remote-subscriber computer and the remote-subscriber computer is online, etc.).

Exemplary Environment and Architecture

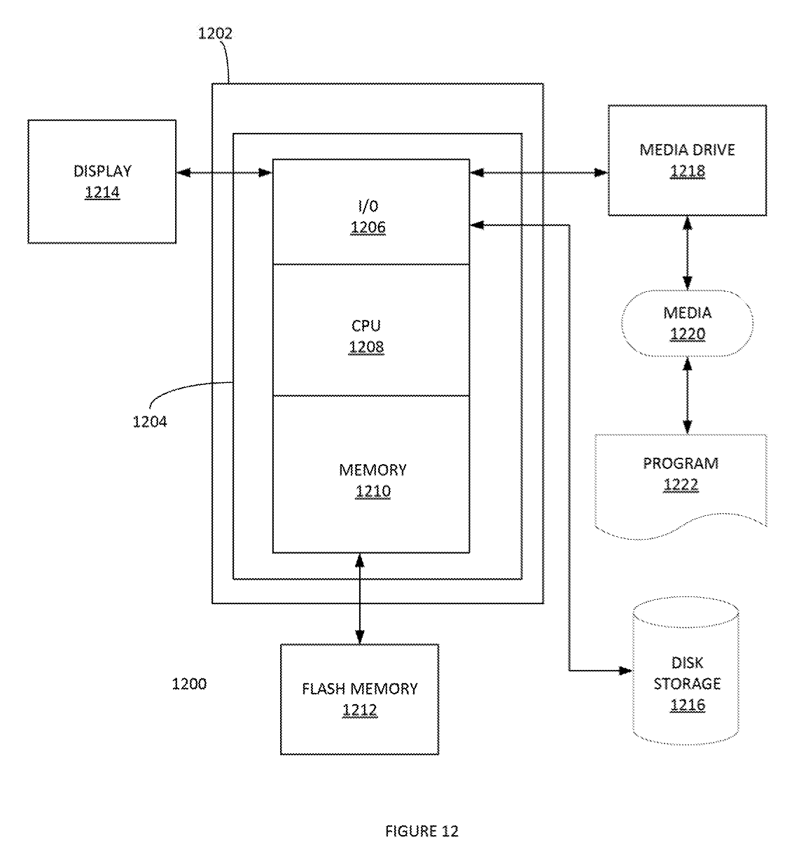

FIG. 12 is a block diagram of a sample-computing environment 1200 that can be utilized to implement some embodiments. The system 1200 further illustrates a system that includes one or more client(s) 1202. The client(s) 1202 can be hardware and/or software (e.g., threads, processes, computing devices). The system 1200 also includes one or more server(s) 1204. The server(s) 1204 can also be hardware and/or software (e.g., threads, processes, computing devices). One possible communication between a client 1202 and a server 1204 may be in the form of a data packet adapted to be transmitted between two or more computer processes. The system 1200 includes a communication framework 1210 that can be employed to facilitate communications between the client(s) 1202 and the server(s) 1204. The client(s) 1202 are connected to one or more client data store(s) 1206 that can be employed to store information local to the client(s) 1202. Similarly, the server(s) 1204 are connected to one or more server data store(s) 1208 that can be employed to store information local to the server(s) 1204. In some embodiments, server(s) 1204 and/or data store(s) 1208 implemented in a cloud computing environment.

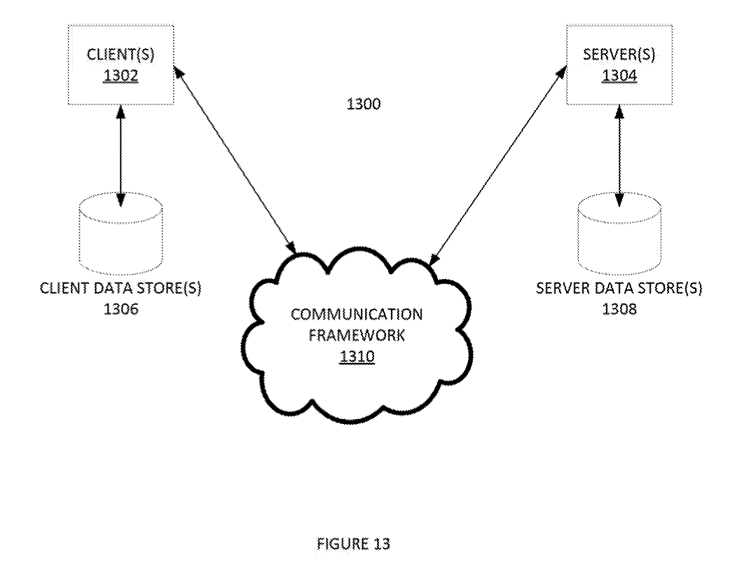

FIG. 13 depicts an exemplary computing system 1300 that can be configured to perform any one of the processes provided herein. In this context, computing system 1300 may include, for example, a processor, memory, storage, and I/O devices (e.g., monitor, keyboard, disk drive, Internet connection, etc.). However, computing system 1300 may include circuitry or other specialized hardware for carrying out some or all aspects of the processes. In some operational settings, computing system 1300 may be configured as a system that includes one or more units, each of which is configured to carry out some aspects of the processes either in software, hardware, or some combination thereof.

FIG. 13 depicts computing system 1300 with a number of components that may be used to perform any of the processes described herein. The main system 1302 includes a motherboard 1304 having an I/O section 1306, one or more central processing units (CPU) 1308, and a memory section 1310, which may have a flash memory card 1312 related to it. The I/O section 1306 can be connected to a display 1314, a keyboard and/or other user input (not shown), a disk storage unit 1316, and a media drive unit 1318. The media drive unit 1318 can read/write a computer-readable medium 1320, which can contain programs 1322 and/or data. Computing system 1300 can include a web browser. Moreover, it is noted that computing system 1300 can be configured to include additional systems in order to fulfill various functionalities.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method for determining a probability value that a real-estate asset is to be placed on the market for sale comprising:
obtaining a database of real-estate assets;
merging a set of similar near real-estate tracts using a breadth-first search;
creating a submarket of real-estate assets by performing cluster analysis with a hierarchal-clustering method in a state context;
identifying a set of datasets of real-estate assets on a per-county level;
identifying a set of datasets of real-estate assets on a per-state level;
determining a probability that each real-estate asset will be placed for sale based on a set of geo-models;
mapping the probability that each real-estate asset will be placed for sale to a score;
implementing one or more weighting methods on the probability for each geo-model to smooth;
calculating a set of ensemble probabilities for each geo-model; and
generating a globalized score for each real-estate asset in the database of real-estate assets.

2. The computerized method of clam 1, wherein the database of real-estate assets comprises tract-level real-estate data, count-level real-estate data, and state-level real-estate data.

3. The computerized method of claim 1, wherein the set of geo-models comprises a tract-level model, quasi-tract model, a submarket-level model, a county-level model, and a state-level model.

4. The computerized method of claim 1 further comprising:
implementing a backtesting operation to determine the probability that each real-estate asset will be placed for sale based on the set of geo-models.

5. The computerized method of claim 1 further comprising:
generating a macro-score and a tract score for each real estate asset in the database of real-estate assets.

6. The computerized method of claim 1 further comprising:
preparing alpha table, wherein the alpha table comprises a set of probabilities from each geo-level model, each historical model coefficient of variation and each historical events rate.

7. The computerized method of claim 6 further comprising:
implementing a first round of weighting operations; and
detecting at least one tract level outliers.

8. The computerized method of claim 7 further comprising:
implementing second round of weighting operations that adjust on a tract level.

9. The computerized method of claim 8 further comprising:
detecting at least one county level outliner; and
implementing a third round of weighting operations that adjust on a county level;

10. The computerized method of claim 9 further comprising:
detecting at least one state level outlier; and
implement fourth round of weighting operations that adjust on a state level.

11. The computerized method of claim 10 further comprising:
formatting the globalized score for each real-estate asset a web page; and

12. The computerized method of claim 11 further comprising:
displaying the globalized score for each real-estate asset on the web page.
